(19) United States
(12) Patent Application Publication
(10) Pub. No.: US 2026/0108955 A1
(43) Pub. Date: Apr. 23, 2026

(54) TOOL-EJECTING DRAWBAR ASSEMBLY

(71) Applicant: Eric Adolph Richter, Lakeland, TN (US)

(72) Inventor: Eric Adolph Richter, Lakeland, TN (US)

(21) Appl. No.: 19/421,495

(22) Filed: Dec. 16, 2025

Related U.S. Application Data
(60) Provisional application No. 63/708,470, filed on Oct. 17, 2024.

(51) Int. Cl. B23B 31/26

(52) U.S. Cl. CPC B23B 31/266

(57) ABSTRACT

A tool-ejecting drawbar assembly for a milling machine is provided. The drawbar assembly includes a drawbar having a machining interface, a tooling interface, and a shoulder disposed between the machining interface and the tooling interface. The machining interface engages a milling machine in operation, and an extraction tool during tool-ejection. The tooling interface mounts a tool within a spindle taper of the milling machine for use in machining operations. The collar is rigidly secured to a retaining nut of the milling machine and includes an aperture that permits passage of the machining interface while interferingly engaging the shoulder. To self-eject a tool the assembly is retracted using the extraction tool such that the collar engages the shoulder forcing the tool from the spindle taper.

### CROSS-REFERENCE TO RELATED APPLICATIONS

This application claims benefit to Provisional Application No. 63/708,470, filed Oct. 17, 2024, the contents of which are herein incorporated by reference.

### BACKGROUND OF THE INVENTION

### Field of Endeavor

The present invention relates generally to milling machine tooling systems, and more particularly to a retrofit spindle assembly for mini and bench milling machines that provides self-actuated tool ejection through mechanical interaction between a shouldered drawbar and a retaining collar.

### Background of Related Art

Mini and bench milling machines are widely used in small-scale manufacturing, prototyping, hobbyist applications, and educational settings. These machines typically employ a drawbar system to secure tool holders within a spindle taper, or quill, such as R8, MT2, or MT3 configurations. The drawbar threads into the tool holder and, when tightened, draws the tapered shank firmly into the quill, creating a friction fit that transmits cutting forces during machining operations.

A persistent challenge with conventional manual drawbar systems in mini and bench milling machines is the difficulty of removing tool holders from the quill. The friction generated during use causes the tool holder to become tightly wedged in the taper. Operators typically must resort to repeated hammering on the drawbar head or use powered impact wrenches to generate sufficient force to break the taper engagement and release the tool holder. This process is time-consuming, physically demanding, and poses several significant drawbacks.

First, the repeated impact forces required to release tool holders can damage sensitive quill bearings, particularly the precision angular contact bearings commonly used in these machines. Such damage leads to reduced quill accuracy, increased runout, and shortened bearing life, ultimately compromising machining quality and requiring costly repairs.

Second, the manual effort and additional equipment required for tool changes reduce operator efficiency and productivity. In production environments or situations requiring frequent tool changes, the cumulative time and effort expended becomes substantial. The physical demands also contribute to operator fatigue and potential strain injuries, particularly to the back, ankles, and feet.

Third, the need for impact tools or hammers introduces safety concerns and creates noise in the work environment. The violent nature of the release process can result in dropped tools or unexpected movement that may cause injury or damage.

Industrial-scale milling machines often employ powered drawbar systems that use pneumatic, hydraulic, or electric actuators to provide controlled axial force for tool ejection. While effective, these systems are bulky, expensive, and require external power sources and control systems. The physical size of such systems makes them impractical for mini and bench milling machines where space around the quill area is severely limited. The cost of these powered systems, often several hundred to several thousand dollars, is disproportionate to the value of the machines themselves, making them economically unfeasible for small-scale applications.

Several attempts have been made to address tool holder release in smaller machines, but existing solutions have significant limitations. Some aftermarket products attempt to provide mechanical advantage through extended handles or lever systems, but these still require substantial manual force and do not eliminate the impact loading on quill bearings. Other approaches involve modifying the quill assembly itself, which can be complex, expensive, and may void manufacturer warranties or compromise the original bearing preload settings that are critical for quill performance.

Accordingly, there exists a need for a tool ejection system for mini and bench milling machines that is compact, cost-effective, preserves quill bearing integrity, and enables rapid tool changes without requiring external power sources or complex modifications to the machine's original design. Such a system would ideally retrofit existing machines without altering critical bearing preload settings and would provide reliable, one-handed tool ejection through a simple mechanical action.

### SUMMARY OF THE INVENTION

Embodiments of the present invention provide a tool-ejecting drawbar assembly for a milling machine. The tool-ejecting drawbar assembly includes a drawbar having a machining interface, a tooling interface, and a shoulder disposed between the machining interface and the tooling interface. The tooling interface configured to mount to a tool within a spindle taper of the milling machine. A collar is rigidly secured to a retaining nut of the milling machine and includes an aperture that permits passage of the machining interface while interferingly engaging the shoulder. The collar and shoulder operate in both an extended configuration and a retracted configuration. In the extended configuration the tool-ejecting drawbar assembly holds the milling tool, such as a tool holder, for cutting, drilling, or otherwise machining materials. In the retracted configuration the shoulder engages the collar such that axial forces are provided to force the tool from the quill taper.

In some embodiments, the collar is secured to the retaining nut by one or more fasteners.

In some embodiments, the retaining nut is a quill bearing retaining nut of the milling machine.

In some embodiments, the aperture is sized to pass the machining interface but block the shoulder by a clearance of 0.1-0.5 mm.

In some embodiments, the contacting surfaces of the shoulder and collar are hardened to at least HRC 50.

In some embodiments, the quill taper is R8, MT2, or MT3, with axial travel producing at least 0.5 mm separation.

### BRIEF DESCRIPTION OF THE DRAWINGS

FIG. 1 is a top perspective view of a tool-ejecting drawbar assembly, according to aspects of the present invention;

FIG. 2 is a bottom perspective view of the tool-ejecting drawbar assembly, according to aspects of the present invention;

FIG. 3 is an exploded view of the tool-ejecting drawbar assembly, according to aspects of the present invention;

FIG. 4 is a top view of tool-ejecting drawbar assembly, according to aspects of the present invention;

FIG. 5 is a cross-sectional view of the tool-ejecting drawbar assembly taken along line 5-5 of FIG. 4, according to aspects of the present invention; and

FIG. 6 is a cross-sectional view of the tool-ejecting drawbar assembly showing a spindle taper and tool holder, according to aspects of the present invention.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

Drawbar assemblies for smaller milling machines, such as bench milling machines and mini-milling machines, typically require manual removal of tool holders, which require the user to exert large forces, or apply power or pneumatic tools. Removal in this manner can pose safety concerns, is inefficient, and/or can damage the machine. Automated system for removal of tool holders exist, but are large, expensive, and impractical for installation on smaller milling machines.

Broadly, an embodiment of the present invention provides a retrofit drawbar assembly for mini and bench milling machines that provides self-actuated tool ejection through mechanical interaction between a shouldered drawbar and a retaining collar.

Broadly, the drawbar of the present invention includes a machining interface for attaching the draw bar to a machine, such as a milling machine, a tooling interface for attaching a tool, such as a tool holder, to the drawbar, and a shoulder

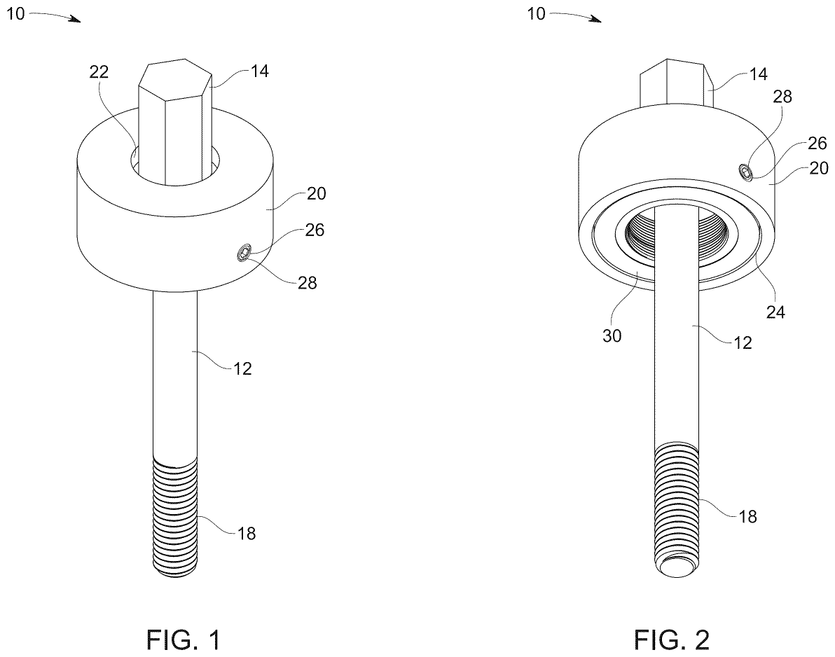

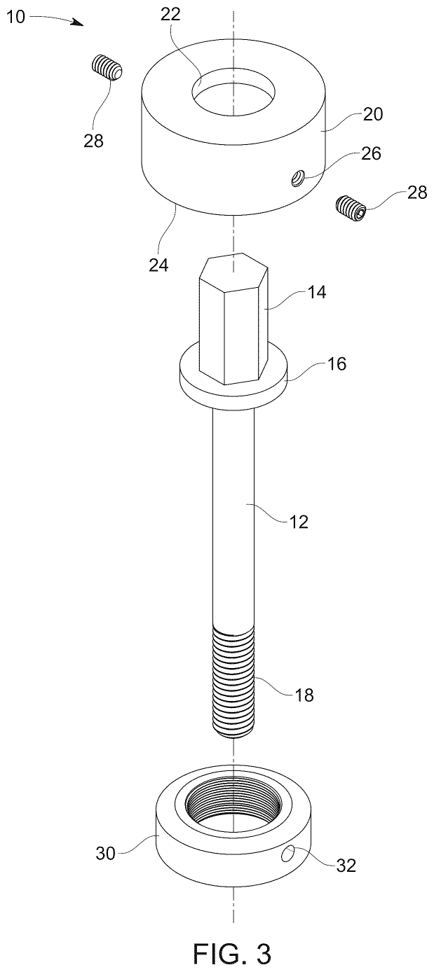

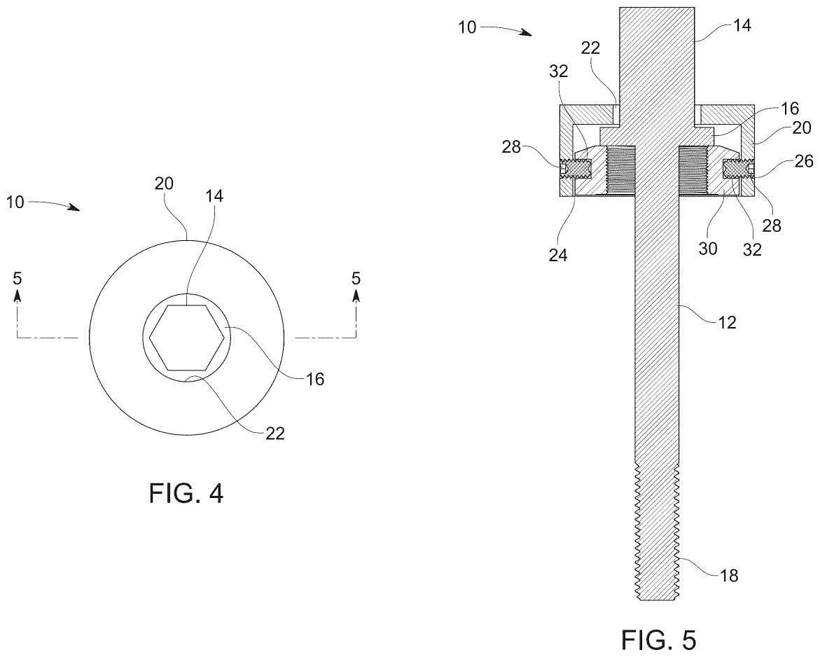

Referring now to the Figures, FIG. 1-6 illustrate aspects of an embodiment of a tool-ejecting drawbar assembly 10, according to aspects of the present invention. The embodiment will be understood, both as to its structure and operation, from the accompanying Figures, taken in conjunction with the accompanying description. Several embodiments of the assembly may be presented herein. It should be understood that various components, parts, and features of the different embodiments may be combined together and/or interchanged with one another, all of which are within the scope of the present application, even though not all variations and particular embodiments are shown in the Figures. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless otherwise described.

FIG. 1-3 illustrate aspects of assembled view(s) and an exploded view of the tool-ejecting drawbar assembly 10, which includes a drawbar 12 having a machining interface disposed on a first end, a shoulder 16, and a tooling interface disposed on a second end. In embodiments, the machining interface is a hex head 14 for attaching the drawbar 12 to a machine, such as a milling machine, but is not so limited. In embodiments, the shoulder 16 is a radial shoulder. In embodiments, the tooling interface is threading 18 for attaching the drawbar 12 to a tool, such as a tool holder 36, but is not so limited.

A collar 20 receives the drawbar 12 with the hex head 14 passing through a bore 22. The bore 22 is dimensioned to allow the hex head 14 to pass, while preventing the shoulder 16 from passing therethrough. The drawbar 12 is secured in the collar 20 by a bearing nut, such as a quill bearing nut 30 disposed in a opening 24 of the collar 20. The quill bearing nut 30 is secured to the collar 20 by one or more collar set screws 28 disposed in one or more set screw slots 26. In embodiments, the quill bearing nut 30 is a quill bearing nut of a milling machine. Advantageously, the tool-ejecting drawbar assembly 10 when rotated in reverse to allows for unthreading of a tool, such as a tool holder, using axial displacement that eliminates the need for external pneumatic, hydraulic, or electric actuators, reduces wear on machine components, and enables rapid tool change operation.

FIG. 5 illustrate aspects of cross-sectional view(s) of the tool-ejecting drawbar assembly 10 without a spindle taper and tool. Specifically, the drawbar 12 is disposed, at least partially, within the collar 20, by placing the machining interface 14 through the bore 22 of the collar 20. In embodiments, the bore 22 and the shoulder 16, as a radial shoulder, are dimensioned such that the shoulder 16 cannot pass through the bore 22. In an exemplary embodiment, the bore 22 is sized to pass the machining interface 14 but block the shoulder 16 by a clearance of 0.1-0.5 mm. In the exemplary embodiment, the clearance indicates a distance between contacting surfaces of the shoulder 26 and collar 20 at an extended configuration.

The drawbar 12 is secured within the collar 20 by a bearing nut, such as the quill bearing nut 30, which can be a quill bearing nut of a milling machine. In embodiments, the shoulder 16 is dimensioned such that it cannot pass through a bore, or aperture of the bearing nut. The collar is secured to the bearing nut using one or more fasteners, such as one or more set screws 28. In embodiments, the collar 20 is aligned with the quill bearing nut 30 using the one or more set screw slots 26 and one or more bearing nut set screw slots 32. Specifically, the one or more set screws 28 can only secure, or fasten, the collar 20 to the quill bearing nut 30 when slots 26 and 32 are in alignment thereby allowing engagement of the one or more set screws.

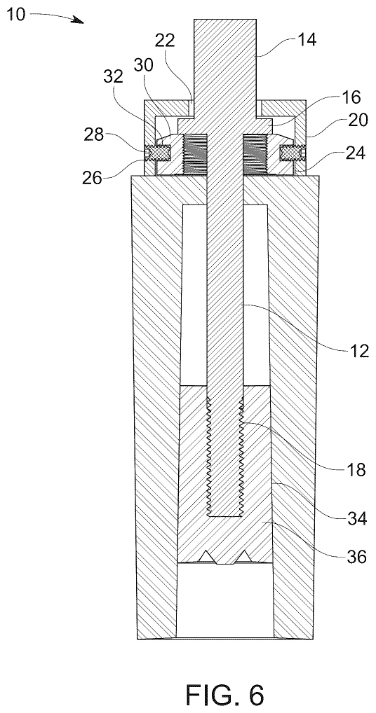

FIG. 6 illustrate aspects of cross-sectional view(s) of the self-ejecting drawbar assembly 10 a spindle taper 34 and tool holder 36. The drawbar 12 of the self-ejecting drawbar assembly 10 is inserted through a bore, or aperture, of the quill taper 34, and a tool is secured to the tooling interface 18. In embodiments, the tool is a tool holder 36 configured to hold a tool, such as a cutting tool, machining tool, drilling tool, etc., in precise alignment. In embodiments, the tool is placed in the tool holder 36 which is drawn into the quill taper 34 thereby securing the tool and providing proper and precise alignment. In embodiments, quill taper 34 one or more of: R8, MT2, or MT3 quil tapers with axial travel producing at least 0.5 mm separation.

In milling operation, or in an extended configuration, the tool-ejecting drawbar assembly 10 when inserted into the quill taper 34 having a tool disposed in the tool holder 36 operates to machine parts during clockwise rotation providing by a milling machine attached via the machining interface 14. During milling operation, the tool and/or tool holder 36 can become locked via frictional forces, within the spindle taper 34. In tool-ejection operation, or in a retracted configuration, a hand tool, such as a ratchet, or wrench, secured to the machining interface 14. The self-ejecting drawbar assembly 10 is rotated counterclockwise causing the drawbar 12, and more specifically the shoulder 16 moves upwardly to contact a surface of the collar 20, i.e. retracted. Once surfaces of the shoulder 16 and the collar 20 contact, continued counterclockwise rotation causes axial forces to eject the tool, and/or tool holder 36, from the quill taper 34. In embodiments, the collar 20, drawbar 14, shoulder 16, and/or contacting surfaces thereof, hardened to at least HRC 50. Advantageously, ejection in this manner eliminates the need for external pneumatic, hydraulic, or electric actuators, reduces wear on machine components, and enables rapid tool changes.

It should be understood, of course, that the foregoing relates to exemplary embodiments of the invention and that modifications may be made without departing from the spirit and scope of the invention as set forth in the following claims.

What is claimed is:

1. A tool-ejecting drawbar assembly for a milling machine, comprising:
a drawbar having a machining interface, a tooling interface, and a shoulder disposed between the machining interface and the tooling interface, the tooling interface configured to mount to a tool within a quill taper;
a collar rigidly secured to a retaining nut of the milling machine, the collar defining an aperture that permits passage of the machining interface while interferingly engaging the shoulder,
wherein, the collar engages the shoulder in a retracted configuration forcing the tool from the quill taper.

2. The assembly of claim 1, wherein the collar is secured to the retaining nut by one or more fasteners.

3. The assembly of claim 2, wherein the retaining nut is a quill bearing retaining nut of the milling machine.

4. The assembly of claim 1, wherein the aperture is sized to pass the machining interface but block the shoulder by a clearance of 0.1-0.5 mm.

5. The assembly of claim 1, wherein contacting surfaces of the shoulder and collar are hardened to at least HRC 50.

6. The assembly of claim 1, wherein the quill taper is R8, MT2, or MT3, with axial travel producing at least 0.5 mm separation.
